(19) United States
(12) Patent Application Publication
(10) Pub. No.: US 2026/0050824 A1
(43) Pub. Date: Feb. 19, 2026

(54) GLOBAL MODEL LOCALIZATION FOR ANOMALY DETECTION

(71) Applicant: Microsoft Technology Licensing, LLC, Redmond, WA (US)

(72) Inventors: Smrati GUPTA, Issaquah, WA (US); Chathra Hasini HENDAHEWA, Toronto (CA); Amer Aref HASSAN, Kirkland, WA (US)

(73) Assignee: Microsoft Technology Licensing, LLC, Redmond, WA (US)

(21) Appl. No.: 18/807,845

(22) Filed: Aug. 16, 2024

(51) Int. Cl. G06N 20/00

(52) U.S. Cl. CPC G06N 20/00

(57) ABSTRACT

A local anomaly detection model for monitoring a local entity set of a network system is generated by applying a transformation function to a global anomaly detection model for the network system, without re-training the global anomaly detection model for the local entity set. The global anomaly detection model, which may be generated via unsupervised learning methods, includes global vector(s) of metrics and a global healthy vector space. The transformation function is estimated and applied to the global anomaly detection model to generate the local anomaly detection model, which includes local vector(s) of metrics pertaining to the local entity set and a local healthy vector space. Responsive to a determination that the local vector(s) of metrics comprises one or more anomalous data points outside of the local healthy vector space, an alert regarding the one or more anomalous data points can be generated and output.

### BACKGROUND

Anomaly detection in system monitoring is a process that involves analyzing data to identify unusual patterns or outliers that deviate significantly from expected behavior. In service provision, it is crucial to leverage anomaly detection to improve operational efficiency, prevent outages, optimize system performance, and ensure performance conforms to Service Level Agreements (SLAs) to maximize customer satisfaction. Detection of anomalies has been studied in both academic and industrial contexts, with various methodologies being used such as multivariate models, deep learning, and reinforcement learning.

A multivariate anomaly detection model can be built based on high-level time series data points (e.g., at a system level), using features representing system usage and/or system behavior. The vector space in which these time series are mapped can enable identification of a space in which data normally lies. Unsupervised machine learning models can be used to distinguish normal system behavior from anomalous system behavior at the global level, where the multivariate data points are clustered and mapped to two dimensions for visualization purposes. However, challenges exist when attempting to convert such global models to a localized space (e.g., a specific geographic region, country, corridor, or tenant). Accordingly, even when a global anomaly detection model already exists, corresponding localized anomaly detection models are typically built “from scratch” which can be time consuming and difficult to manage.

### SUMMARY

In summary, the detailed description presents innovations in global model localization for anomaly detection. A transformation method which employs a cost function is performed to map a global anomaly detection model to one or more localized spaces. Towards this end, an anomaly detection tool collects metrics pertaining to a global entity set of a network system and generates a global anomaly detection model for the global entity set via unsupervised machine learning. The global anomaly detection model includes one or more global vectors of metrics pertaining to the global entity set and a global healthy vector space. The anomaly detection tool then estimates a transformation function to apply to the global anomaly detection model to generate a local anomaly detection model for a local entity set of the network system which is a subset of the global entity set. The estimation of the transformation function uses at least some of the one or more global vectors of metrics pertaining to the global entity set. The anomaly detection tool then generates the local anomaly detection model by applying the transformation function to the global anomaly detection model (e.g., without performing any additional training specific to the local entity set). The resulting local anomaly detection model includes one or more local vectors of metrics pertaining to the local entity set and a local healthy vector space.

Anomalies pertaining to the local entity set can be detected by deploying the local anomaly detection model in the network system. For example, the anomaly detection tool can analyze the local anomaly detection model to determine whether the metrics include any data points outside of a healthy data vector space of the local anomaly detection model and output results of the anomaly detection for the local entity set. For example, responsive to a determination that one or more data points are outside of the healthy data vector space of the local anomaly detection model, the anomaly detection tool can output an alert regarding the anomalous data point(s), output an indication of a suspected root cause for the anomalous data point(s), Additionally or alternatively, the anomaly detection tool can adjust network system parameter(s) in view of the anomalous data point(s), e.g., without user prompting or intervention.

The global anomaly detection model can include a machine learning model which was trained via unsupervised techniques for distinguishing anomalous data points from normal data points. In contrast, the local anomaly detection models described herein are generated as projections of the global anomaly detection model, which can advantageously reduce the complexity which is typically associated with re-training an anomaly detection model for a localized space.

The innovations described herein can be implemented as part of a method, as part of a computer system (physical or virtual, as described below) configured to perform the method, or as part of a tangible computer-readable media storing computer-executable instructions for causing one or more processors, when programmed thereby, to perform the method. The various innovations can be used in combination or separately. The innovations described herein include the innovations covered by the claims. This summary is provided to introduce a selection of concepts in a simplified form that are further described below in the detailed description. This summary is not intended to identify key features or essential features of the claimed subject matter, nor is it intended to be used to limit the scope of the claimed subject matter. The foregoing and other objects, features, and advantages of the invention will become more apparent from the following detailed description, which proceeds with reference to the accompanying figures and illustrates a number of examples. Examples may also be capable of other and different applications, and some details may be modified in various respects all without departing from the spirit and scope of the disclosed innovations.

### BRIEF DESCRIPTION OF THE DRAWINGS

FIG. 1 is a diagram of an example computer system in which some described embodiments can be implemented.

FIG. 2 is a diagram illustrating an example architecture for global model localization for anomaly detection.

FIG. 3 is a diagram illustrating an example graph of data points for a global anomaly detection model.

FIG. 4 is a diagram illustrating an example graph of data points upon transformation of a global anomaly detection model to a local anomaly detection model.

FIG. 5 is a flowchart illustrating a generalized technique for localizing a global anomaly detection model.

FIG. 6 is a flowchart illustrating a generalized technique for estimating a transformation function to apply to a global anomaly detection model to generate a local anomaly detection model

FIG. 7 is a flowchart illustrating a generalized technique for re-estimating a transformation function to apply to a global anomaly detection model to re-generate a local anomaly detection model.

FIG. 8 is a flowchart illustrating a generalized technique for outputting results of anomaly detection performed by a deployed local anomaly detection model.

FIGS. 9-10 are diagrams illustrating features of example user interfaces for displaying anomaly detection results.

### DETAILED DESCRIPTION

The detailed description presents innovations in global model localization for anomaly detection. These innovations can provide quicker and more efficient generation of anomaly detection models for localized spaces.

In particular, the technologies described herein provide technical solutions to the technical problems associated with localizing global anomaly detection models. One such technical problem involves the need to convert a global anomaly detection model to a more local space (e.g., a specific geography, country, corridor, or tenant). Existing techniques for generating local anomaly detection models involve re-building a model for each localized space from scratch, which can be time consuming and difficult to effectively manage.

Technical solutions provided by the technologies disclosed herein include methods and systems for transformation of a global anomaly detection model to a local anomaly detection model without requiring model re-training. The global anomaly detection model includes one or more global vectors of metrics pertaining to a global entity set. Each entity of the global entity set represents one or more computing devices (e.g., cloud computing devices associated with a cloud-based service). In accordance with the technologies disclosed herein, a transformation function which can be applied to transform the global anomaly detection model into a local anomaly detection model is estimated using at least some of the one or more global vectors of metrics pertaining to the global entity set. Estimating the transformation function can include employing a cost function to estimate a scaling factor for a given local entity set which is a subset of a global entity set. The scaling factor can then be applied to generate a local anomaly detection model for the local entity set as a projection of the global anomaly detection model, as opposed to the usual technique in which the global anomaly detection model is re-trained with data specific to the local entity set. Accordingly, the technologies disclosed herein provide technical advantages, such as reducing the complexity, processing burden, and time required to localize a global anomaly detection model.

Additional technical advantages provided by the technologies disclosed herein include enhanced monitoring of anomalies via client-side triggering of local anomaly detection model re-generation. An anomaly detection tool implemented by a network system can receive a request from a client application to re-generate a local anomaly detection model for a given local space. For example, if a client application of a cloud-based communication service detects a trend of performance issues during voice calls, the client application can transmit a request to the service for re-generation of a local anomaly detection model for a particular local space (e.g., a communication corridor utilized by the client application). In response to the request, an anomaly detection tool implemented by the service can re-estimate a previously-estimated transformation function for the local entity set and apply the re-estimated transformation function to a global anomaly detection model for the service to re-generate the local anomaly detection model for the local space in question. The re-generated local anomaly detection model can then be re-deployed to output more accurate anomaly detection results, which in turn can be addressed on the server side (e.g., automatically via adjustment of network system parameter(s) in response to output of the anomaly detection tool, or via user actions taken on the server side in response to alerts and root cause information output by the anomaly detection tool).

As a further advantage, client-side triggering of local anomaly detection model re-generation provides additional metrics to the network system. For example, the anomaly detection tool can track model re-generation requests, which can serve as additional indicators of network performance issues or other metrics.

Still further, anomalous network system behavior can advantageously be detected at a high level of granularity via the techniques described herein. For example, local anomaly detection models can be generated for increasingly small local entity sets, and even for a local entity set that includes exactly one entity. In this way, the source of an anomaly can be identified without the burdensome process of re-training the global model for each local entity set.

In the examples described herein, identical reference numbers in different figures indicate an identical component, module, or operation. More generally, various alternatives to the examples described herein are possible. For example, some of the methods described herein can be altered by changing the ordering of the method acts described, by splitting, repeating, or omitting certain method acts, etc. The various aspects of the disclosed technology can be used in combination or separately. Some of the innovations described herein address one or more of the problems noted in the background. Typically, a given technique/tool does not solve all such problems. It is to be understood that other examples may be utilized and that structural, logical, software, hardware, and electrical changes may be made without departing from the scope of the disclosure. The following description is, therefore, not to be taken in a limited sense.

### I. USE CASE SCENARIOS

Innovations in global model localization for anomaly detection as described herein can be used in various use case scenarios. In general, the network monitoring tool described herein can collect metrics pertaining to any network system of computing entities. The entities can be collectively referred to as a global entity set, which can be divided into different subsets of entities. In this context, the term “global” is used to indicate that the global entity set is an overall (e.g., comprehensive) set of the computing entities of the network system; alternatively, the global entity set may be referred to more simply as an entity set. A given subset of entities can include entities located within a common geographic region or country, entities associated with a common industry segment, entities associated with a common network tenant, entities associated with a common communication corridor, and the like. The metrics can include, for example, performance metrics, volume metrics, and client-side metrics.

In some use case scenarios, the network system is a cloud-based network of cloud servers which collectively provide a cloud-based service. The cloud servers may be distributed across multiple data centers and geographic regions and interconnected through a cloud network infrastructure managed by a cloud provider. In contrast, client computing devices which subscribe to the service interact may with the cloud servers over a public network, e.g., the Internet.

As one example, the service may be a cloud-based voice service that enables users to make and receive phone calls within a client application. As another example, the service may be a cloud-based collaboration and communication platform that enables users to communicate in various ways (e.g., voice calls, video calls, text chat, etc.) and also provides storage, email, and file sharing capabilities, among other functionality. As yet another example, the service may be a cloud-based application suite providing functionality such as enterprise resource planning (ERP) and/or customer relationship management (CRM).

### II. EXAMPLE COMPUTER SYSTEMS

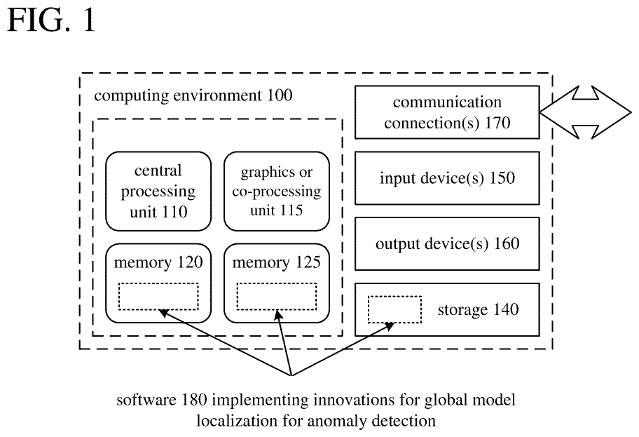

FIG. 1 illustrates a generalized example of a computer system (100) in which several of the described innovations may be implemented. The computer system (100) is not intended to suggest any limitation as to scope of use or functionality, as the innovations may be implemented in diverse computer systems, including special-purpose computer systems adapted for network analysis.

With reference to FIG. 1, the computer system (100) includes one or more processing units (110, 115) and memory (120, 125). The processing units (110, 115) execute computer-executable instructions. A processing unit can be a central processing unit (“CPU”), processor in an application-specific integrated circuit (“ASIC”) or any other type of processor. In a multi-processing system, multiple processing units execute computer-executable instructions to increase processing power. For example, FIG. 1 shows a central processing unit (110) as well as a graphics processing unit or co-processing unit (115). The tangible memory (120, 125) may be volatile memory (e.g., registers, cache, RAM), non-volatile memory (e.g., ROM, EEPROM, flash memory, etc.), or some combination of the two, accessible by the processing unit(s). The memory (120, 125) stores software (180) implementing one or more innovations for global model localization for anomaly detection, in the form of computer-executable instructions suitable for execution by the processing unit(s).

A computer system may have additional features. For example, the computer system (100) includes storage (140), one or more input devices (150), one or more output devices (160), and one or more communication connections (170). An interconnection mechanism (not shown) such as a bus, controller, or network interconnects the components of the computer system (100). Typically, OS software (not shown) provides an operating environment for other software executing in the computer system (100), and coordinates activities of the components of the computer system (100).

The tangible storage (140) may be removable or non-removable, and includes magnetic disks, magnetic tapes or cassettes, CD-ROMs, DVDs, or any other medium which can be used to store information and which can be accessed within the computer system (100). The storage (140) stores instructions for the software (180) implementing one or more innovations for global model localization for anomaly detection.

The input device(s) (150) may be a touch input device such as a keyboard, mouse, pen, or trackball, a voice input device, a scanning device, touchscreen, or another device that provides input to the computer system (100). The output device(s) (160) may be a display, printer, speaker, CD-writer, or another device that provides output from the computer system (100).

The communication connection(s) (170) enable communication over a communication medium to another computing entity. The communication medium conveys information such as computer-executable instructions or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the general context of non-transitory computer-readable media. Non-transitory computer-readable media are any available tangible media that can be accessed within a computing environment. By way of example, and not limitation, with the computer system (100), non-transitory computer-readable media include memory (120, 125), storage (140), and combinations of any of the above.

The innovations can be described in the general context of computer-executable instructions, such as those included in modules, being executed in a computer system on a target real or virtual processor. Generally, modules include routines, programs, libraries, objects, classes, components, data structures, etc. that perform particular tasks or implement particular abstract data types. The functionality of the modules may be combined or split between modules as desired in various embodiments. Computer-executable instructions for modules may be executed within a local or distributed computer system.

The terms “system” and “device” are used interchangeably herein. Unless the context clearly indicates otherwise, neither term implies any limitation on a type of computer system or device. In general, a computer system or device can be local or distributed, and can include any combination of special-purpose hardware and/or hardware with software implementing the functionality described herein. The disclosed methods can be implemented using specialized computing hardware configured to perform any of the disclosed methods. For example, the disclosed methods can be implemented by an integrated circuit (e.g., an ASIC such as an ASIC digital signal processor (“DSP”), a graphics processing unit (“GPU”), or a programmable logic device (“PLD”), such as a field programmable gate array (“FPGA”)) specially designed or configured to implement any of the disclosed methods.

For the sake of presentation, the detailed description uses terms like “determine” and “use” to describe computer operations in a computer system. These terms denote operations performed by a computer, and should not be confused with acts performed by a human being. The actual computer operations corresponding to these terms vary depending on implementation.

### III. EXAMPLE ARCHITECTURE FOR GLOBAL MODEL LOCALIZATION FOR ANOMALY DETECTION

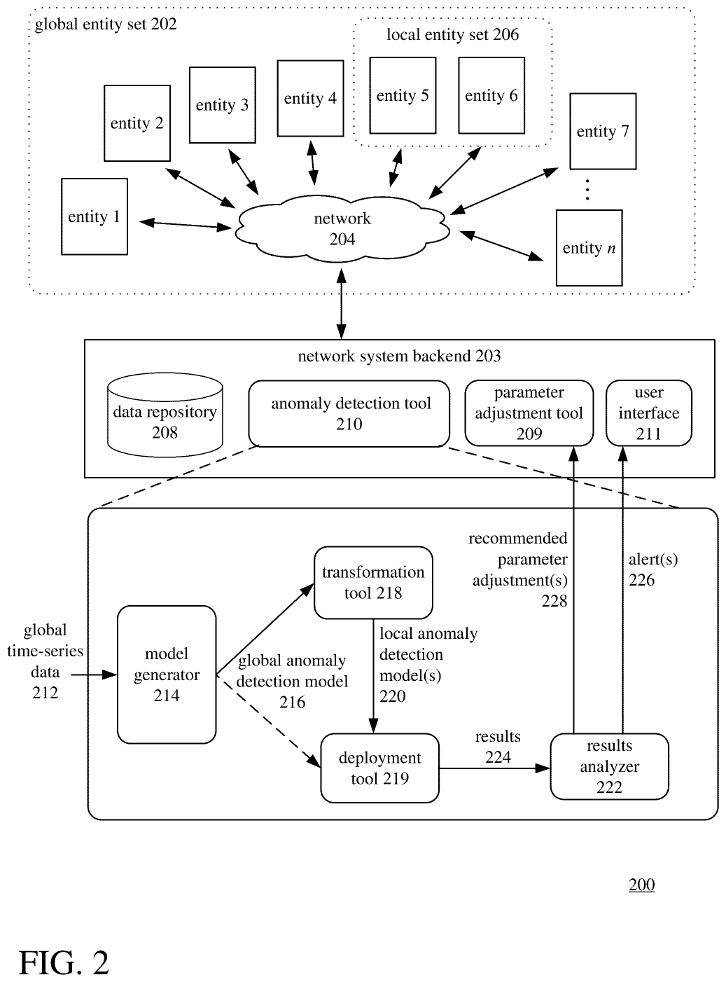

FIG. 2 shows an example architecture for global model localization for anomaly detection in a distributed computer network system (200) that includes a global entity set (202) and a network system backend (203). The global entity set (202), which can be referred to more simply as an entity set, includes multiple entities (e.g., computing nodes), labeled entity 1 to entity n in FIG. 2. The multiple entities 1 . . . n are connected over a network (204) such as the Internet. As used herein, the term “entity” refers to a computer system such as computer system (100) of FIG. 1. A single entity may represent a single computing device/node or computer system, whereas a composite entity may include a plurality of computing devices or computer systems. In some examples, network (204) is a cloud network and entities 1 . . . n are cloud computing devices, such as cloud servers.

As shown, a local entity set (206) includes a subset of the entities of the global entity set (202). While the depicted local entity set (206) includes entities 5 and 6 for the sake of example, another subset of the global entity set (202) may alternatively be included in the local entity set (206). While a single local entity set (206) is shown, the global entity set (202) may be subdivided into a plurality of local entity sets in practice, with each local entity set comprising a respective one or more entities selected from the global entity set (202). A relatively small number of entities is shown in FIG. 2 for ease of explanation; in practice, the global entity set (202) and local entity set (206) may each include, for example, tens, hundreds, or thousands of entities. In any case, the global entity set (202) will always include a greater number of entities than the local entity set (206). The local entity set (206), while never empty, may include only a single entity in some examples.

The global entity set (202) can include a plurality of entities which collectively form a composite global entity such as a cloud service or distributed cloud application, whereas each local entity set (206) may represent a localized portion of the global entity. As one example, the global entity may be a geographic area encompassing Earth or a large portion of Earth, and each local entity set may include entities which are physically located in or otherwise associated with a specific geographic area or political district (e.g., country) on Earth. As another example, the global entity may include a plurality of communication (e.g., call) corridors, and each local entity set may include entities associated with a specific one of the corridors (e.g., a call corridor between two countries). As yet another example, the global entity may include a plurality of tenants (e.g., enterprises or other customers of a cloud network), and each tenant may include a plurality of associated entities.

The network system backend (203), which is also connected to network (204), can be distributed among multiple computer systems or entities, or alternatively, implemented by a single computer system or entity. In the example, the network system backend (203) includes a data repository (208), a parameter adjustment tool (209), an anomaly detection tool (210), and a user interface (UI) (211). While the network system backend (203) is depicted as being external to (e.g., not part of) the global entity set (202), the network system backend (203) and the components thereof may alternatively be implemented by one or more of the entities 1 . . . n.

The data repository (208) can include computer-readable storage media which stores data regarding the network system (200) and the entities thereof (e.g., global time-series data). The data can include values of metrics associated with the network system (200). The metrics can include performance metrics, volume metrics, client-side metrics, or another type of metrics. In an example where the network system implements a cloud-based voice call service, the metrics can include, for example, a number of call attempts, a number of calls established, a number of minutes of use, a jitter measurement, a Session Engagement Establishment Ratio (SEER), and/or a Response Code distribution (RCD). The metrics can be collected through server-side telemetry and/or client-side telemetry, for example.

In the depicted example, the network system backend (203) runs an anomaly detection tool (210). For example, the network system backend (203) can include software which implements the anomaly detection tool (210). In practice, the anomaly detection tool (210) may alternatively run on one of the entities 1 . . . n of the global entity set, or on multiple of the entities 1 . . . n in a distributed manner. In the example, the anomaly detection tool (210) includes a model generator (214), a transformation tool (218), a deployment tool (219), and a results analyzer (222), all of which can be implemented as software modules or in another manner.

As shown, the anomaly detection tool (210) is configured to receive global time-series data (212). The global time-series data (212) may be received at the network system backend (203) from the entities 1 . . . n, or in another manner. The global time-series data (212) may represent measurements of metrics collected over time, such as metrics regarding the performance of the network (204) and/or metrics regarding one or more of the entities 1 . . . n of the global entity set (202). In some examples, the global time-series data is stored in data repository (208) and subsequently fetched from data repository (208) by the anomaly detection tool (210).

The global time-series data (212) serves as an input to the model generator (214) of the anomaly detection tool (210). The model generator (214) is configured to generate a global anomaly detection model (216) based at least in part on the global time-series data (212), as described further herein. The global anomaly detection model (216), which can be referred to more simply as an anomaly detection model, serves as an input to the transformation tool (218) which is configured to generate one or more local anomaly detection models (220) by applying a transformation function (per local anomaly detection model) to the global anomaly detection model (216) as described herein.

The local anomaly detection model(s) (220) generated via transformation tool (218) are input to a deployment tool (219) of the anomaly detection tool (210) for deployment. Optionally, as shown, the global anomaly detection model (216) can also be input to the deployment tool (219) for deployment. As used herein, “deployment” of a global or local anomaly detection model refers to operating the model to analyze real-time incoming data (e.g., live time-series data) and identify anomalies in the data. In the example, the deployment tool (219) transmits results (224) generated during the deployment of the model(s) to a results analyzer (222).

The results analyzer (222) can include a software module configured to analyze the results (224) and initiate actions based on the analysis. The actions initiated by results analyzer (222) can include, for example, outputting one or more alerts (226) based on analysis of the results (224), and optionally, determining and outputting root cause information for an alert. For example, an alert (226) may be output in response to identification of an anomalous data point (e.g., a data point located outside of a local healthy vector space, as described further herein). In this context, the root cause information for the alert (226) can include one or more suspected reasons why the anomalous data point is located outside of the local healthy vector space. As another example, for entities in a specific corridor (e.g., US and Canada) of a cloud-based voice call service, an example root cause for an alert could be a misconfiguration in one of the main carrier hubs due to a new system update that is resulting in call drops.

In the depicted example, the alert(s) (226) and optional root cause information are transmitted to the UI (211) of the network system backend (203) for display. For example, the UI (211) can display a dashboard which depicts metrics and associated alerts and root cause information. In other examples, however, the alert(s) and optional root cause information may be transmitted elsewhere.

As shown, the results analyzer (222) can also output one or more recommended parameter adjustments (228) for the network system (200) based on analysis of the results (224). In the depicted example, the recommended parameter adjustment(s) are transmitted to the parameter adjustment tool (209). The parameter adjustment tool (209) can then implement the recommend parameter adjustment(s) (228) in the network system (200). In some examples, the parameter adjustment tool (209) implements the recommended parameter adjustments automatically (e.g., without any user intervention) in the network system backend (203), network (204), and/or one or more of the entities 1 . . . n. Example parameters of the network system (200) that may be adjusted include a routing table of the network system, an allocation of computing resources within the network system, and an allocation of memory within the network system.

Alternatively, the recommended parameter adjustment(s) (228) may be transmitted to the UI (211) for display. In such examples, a user (e.g., an administrative user of the network system (200)) may be prompted to confirm (e.g., via user input to the UI (211)) that the recommended parameter adjustment(s) (228) should be implemented.

As an illustrative example, the local anomaly detection model can include one or more local vectors of metrics and a local healthy vector space. The results analyzer (222) can analyze the results (224) to identify data points of the one or more local vectors of metrics which are located outside of the local healthy vector space, and designate any such data points as anomalous data points. One or more anomalous data points can serve as the basis for an alert (226) displayed to a user via the UI (211). Optionally, the results analyzer (222) can analyze the local anomaly detection model to determine (e.g., infer) a root cause for the anomalous data point(s). The results analyzer (222) can then transmit the alert (226), and any determined root cause information, to the UI (211) for display. Alternatively or additionally, the results analyzer (222) can formulate one or more recommended parameter adjustments (228) to be enacted by the network system backend (203) in order to correct the anomalous behavior.

While FIG. 2 depicts the model generator (214), transformation tool (218), deployment tool (219), and results analyzer (222) of the anomaly detection tool (210) as being collocated, these components can instead be located at different computer systems or entities connected to network (204).

### IV. UNSUPERVISED ANOMALY DETECTION MODELS, IN GENERAL

Unsupervised anomaly detection models may be used to identify unusual or anomalous data points in a dataset without relying on labeled examples of anomalies. Such models may be employed when labeled data for anomalies is unavailable or difficult to obtain, especially for rare cases such as system anomalies where the training labels are sparse. At a high level, unsupervised anomaly detection models work by representing each data instance (e.g., network entity) as a vector in a high-dimensional space, where each dimension corresponds to one or more features or attributes of the data. The model aims to learn the normal patterns or distributions of these vectors in the vector space using only the available (unlabeled) data, in order to be able to identify deviations from the normal behavior. Such abnormal patterns would be located away from the nucleus of the normal patterns in the vector space and thus would be considered as probable anomalies.

Towards this end, each data instance may be converted into a vector representation, where each element of the vector corresponds to a specific feature or attribute of the data. The anomaly detection model can then be trained on the vectorized data, using the assumption that the majority of the vectorized data represents normal data instances. In this way, the anomaly detection model can learn the typical patterns, distributions, or clusters of these vectors in the high-dimensional vector space.

Once the anomaly detection model has learned the normal patterns, it can recognize anomalous data based on how different or distant it is from the learned normal patterns. Common techniques for recognizing anomalous data include density-based methods, reconstruction-based methods, and distance-based methods. In density-based methods, anomalies can be identified as vectors that lie in low-density regions of the vector space, far from the dense clusters of normal vectors. In reconstruction-based methods, the anomaly detection model can learn to reconstruct or generate normal vectors, and anomalies are identified as vectors that have high reconstruction errors. In distance-based methods, anomalies are identified as vectors that are far away from the centroid or mean of the normal vectors, based on distance metrics such as Euclidean distance or Mahalanobis distance.

Some examples of unsupervised anomaly detection models that operate on vector representations include models incorporating the Isolation Forest algorithm, One-Class Support Vector Machines (OC-SVM), Autoencoders, and Generative Adversarial Networks (GANs).

### V. EXAMPLE GLOBAL ANOMALY DETECTION MODEL

A multivariate anomaly detection model for a global entity set may be built based on time-series data associated with the global entity set, using features representing usage and/or behavior of the global entity set, as well as relationships or activity between the entities (e.g., network activity between the entities). The vector space in which the time series data are mapped can enable identification of a space in which the data normally lies. Using unsupervised learning models, normal behavior can be distinguished from anomalous behavior at the global level. The multivariate data points may be clustered and mapped to two dimensions for visualization purposes.

A global vector space B_{global} can be defined as a function ƒ_{g}(a_{g}, b_{q}, c_{g}, . . . n_{g}), where a_{g}, b_{q}, c_{g}, . . . n_{g} each represent an individual feature associated with a global entity set such as global entity set (202) of FIG. 2. The features included in B_{global} will vary depending on the use case and the nature of the global entity set. For example, in the context of a cloud voice call service, examples of features (a, b, . . . , n) can include metrics indicative of call quality such as a number of call attempts, a number of calls established, minutes of use, jitter, Session Engagement Establishment Ratio (SEER), Response Code distribution (RCD), and the like.

In contrast, a healthy global vector space C_{global} is equal to the sum of B_{global} and δ_{g}, where 0<δ_{g}<N_{g}, δ_{g} represents an expected deviation between C_{global} and B_{global}, and N_{g} indicates a maximum threshold that causes a data point to move from a normal cluster to an anomalous cluster. In particular, if δ_{g}>N_{g}, then the data points in consideration may be considered as deviating from healthy system or network behavior to unhealthy (e.g., anomalous) system or network behavior. Depending on the use case, N_{g} may be a vector specifying a set of constraints that pertain to the global entity set, such as an SLA for operation of a system such as a cloud service. As an example, in the context of a cloud voice call service, the vector N_{g} can specify an SLA for operation of the service with threshold acceptable values for metrics indicative of call quality such as a number of call attempts, a number of calls established, minutes of use, jitter, SEER, RCD, and the like.

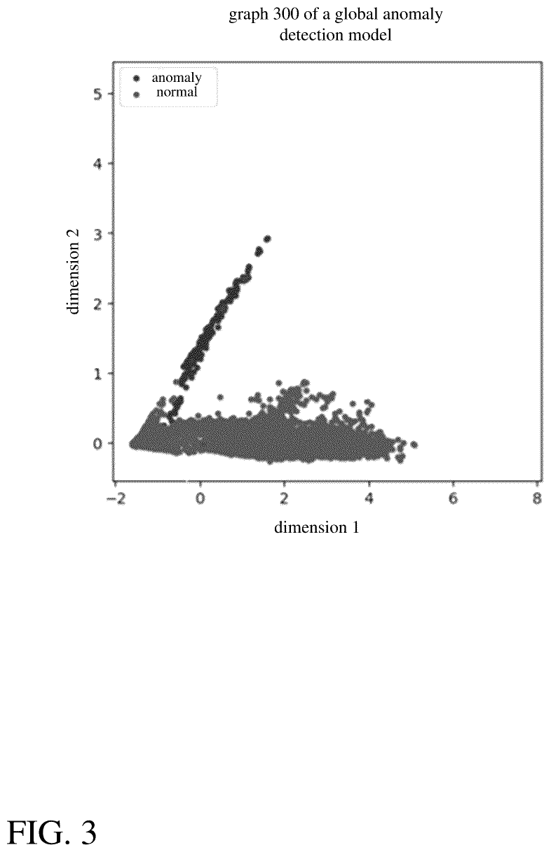

FIG. 3 shows an example graph (300) of data points of a global anomaly detection model. As indicated by the legend, normal data points (e.g., data points that lie within the healthy global vector space C_{global}) are denoted by a lighter shade of gray, whereas anomalous data points (e.g., data points that lie outside of C_{global}) are denoted by a darker shade of gray. In the example, the x-axis is labeled dimension 1, whereas the y-axis is labeled dimension 2.

In practice, dimension 1 and dimension 2 can each represent multiple features. In particular, dimensionality reduction may be performed in order to illustrate more than two metrics on a two-dimensional graph. For example, the x-coordinate value of a given data point on the graph can be the sum of values of a first plurality of metrics, and the y-coordinate value of the given data point on the graph can be the sum of values of a second plurality of metrics. In the context of a cloud voice call service, the x-coordinate value of a given data point might be, for example, the sum of a jitter value and a bandwidth value, whereas the y-coordinate value of the given data point might be, for example, the sum of a number of call attempts and a number of calls established.

### VI. EXAMPLE TRANSFORMATION OF A GLOBAL ANOMALY DETECTION MODEL INTO A LOCAL ANOMALY DETECTION MODEL

In accordance with the techniques described herein, a transformation function is employed to convert data points, as well as the expected deviation δ_{g}, from the global vector space B_{global} to a local vector space B_{local}. Similar to B_{global}, B_{local} can be defined as a function ƒₗ(aₗ, bₗ, cₗ, . . . nₗ), where aₗ, bₗ, cₗ, . . . nₗ each represent an individual metric associated with a local entity set such as local entity set (206) of FIG. 2. The transformation function can include one or more scaling factors θₗ, where the value(s) of the scaling factor(s) θₗ are determined such that the product of θₗ and B_{global} is approximately equal to B_{local}.

Similarly, a healthy local vector space C_{local} can be determined as the product of the scaling factor(s) θₗ and the healthy global vector space C_{global} (and thus, as the product of (B_{global}+δ_{g}) and θₗ). The distributive property can be employed to arrive at the equation C_{local}=θₗ*B_{global}+θₗ*δ_{g}, where δ_{g}<N_{g} and δ_{g}>0.

For ease of explanation, the examples described herein focus on transformation functions that include a single scaling factor θₗ. In practice, a transformation function may involve more than one variable or metric, and thus may incorporate multiple scaling factors θₗ, among other parameters. For example, a transformation function which takes into account an SLA metric as well as a customer impact metric may include a respective scaling factor for each of these metrics.

As described herein, the transformation function, and the components thereof (e.g., the scaling factor(s)) can be estimated using at least some of the one or more global vectors of metrics pertaining to the global entity set.

a. Example Approaches for Determining θₗ.

As described herein, estimating the transformation function used to localize a global anomaly detection model can include estimating a scaling factor θₗ. In particular, a respective scaling factor θₗ can be estimated for each local entity set in order to transform the global anomaly detection model into a corresponding local anomaly detection model for that local entity set. Example approaches for estimating the scaling factor θₗ include performing regression analysis (e.g., non-linear non-parametric regression analysis) using at least some of the one or more global vectors of metrics pertaining to the global entity set, performing machine learning using at least some of the one or more global vectors of metrics pertaining to the global entity set, or evaluating a cost function using at least some of the one or more global vectors of metrics pertaining to the global entity set.

For example, the scaling factor(s) θₗ in the transformation function can be learned via regression analysis using historical data of the one or more global vectors of metrics pertaining to the global entity set that is relevant to the global and local vector spaces and based on impact criteria of interest. For example, data such as SLAs and a number of impacted customers due to anomalies in historical data for the global and local vector spaces can be fed into a regression model, which in turn can learn the coefficients of the transformation function that best fit the data. If there are multiple metrics considered together, a transformation function including multiple scaling factors θₗ may be learned via the regression model. In contrast, if only a single metric is considered, a transformation function including a single scaling factor θₗ may be learned via the regression model.

In some examples, a cost function can be employed to estimate the scaling factor θₗ (e.g., a cost function which aims to optimize for a specific parameter or parameters). For example, a cost function can be evaluated using at least some of the one or more global vectors of metrics pertaining to the global entity set. Example cost functions are described below. Alternatively, another type of function may be employed to estimate the scaling factor θₗ.

One example cost function that may be employed to estimate the scaling factor θₗ is a cost function that takes into account the expected time to mitigate an anomaly in the global vector space B_{global} and the expected time to mitigate the anomaly in the local vector space B_{local}. For example, in a use case where an SLA is in place for the global entity set, the SLA may specify expected mitigation times for global system outages versus a localized outage (e.g., an outage specific to a local entity set within the global entity set, such as an entity set in a specific geographic location). The expected mitigation times may be used to optimize for the scaling factor θₗ.

Another example cost function that may be employed to estimate Or is a cost function that takes into account the ratio of users impacted in local scenarios compared to the number of total global users. Use of such a cost function may make it possible to determine a monetary cost associated with an impacted usage drop. For example, in a use case where the global entity set includes entities associated with a plurality of call corridors (e.g., US to Canada, Singapore to UK, etc.), and each call corridor represents a respective local entity set, the total number of users impacted by an outage globally can be compared to the number of users in impacted by the outage each local call corridor. Table 1 below shows example metrics associated with an outage and corresponding θₗ values determined based on the metrics.

TABLE 1
Example Impact Ratio Metrics and Θₗ Values.

| | Global | Local | Local |
|---|---|---|---|
| Metric | (worldwide) | (US-Canada) | (Singapore-UK) |
| Number of total | 100,000 | 67,000 | 5,100 |
| users | | | |
| Number of users | 85,000 | 58,000 | 2,500 |
| impacted due to | | | |
| outage | | | |
| Ratio of impact | 0.8500 | 0.8657 | 0.4902 |
| Θₗ | 1.0 | 1.0184 | 0.5767 |

In the example shown in Table 1, the ratio of global users impacted due to an outage is determined as the quotient of the number of global users impacted due to the outage and the number of total global users (85K/100K=0.85). Similarly, for each local corridor (US-Canada and Singapore-UK in the example), the ratio of local users impacted due to the outage is determined as the quotient of the number of local users impacted due to the outage and the number of total local users (58K/67K=0.8657 or 2.5K/5.1K=0.4902). A θₗ value for each local corridor is then determined by finding the quotient of the ratio of local users impacted due to the outage and the ratio of global users impacted due to the outage. In the example, the θₗ value for the US-Canada corridor is equal to 0.8657/0.8500 (i.e., 1.0184), whereas the θₗ value for the Singapore-UK corridor is equal to 0.4902/0.8500 (i.e., 0.5767). A healthy local vector space C_{local} can be determined for each local entity set (e.g., each corridor) as the product of (B_{global}+δ_{g}) and the corresponding Or value (e.g., 1.0184 for the US-Canada corridor and 0.5767 for the Singapore-UK corridor).

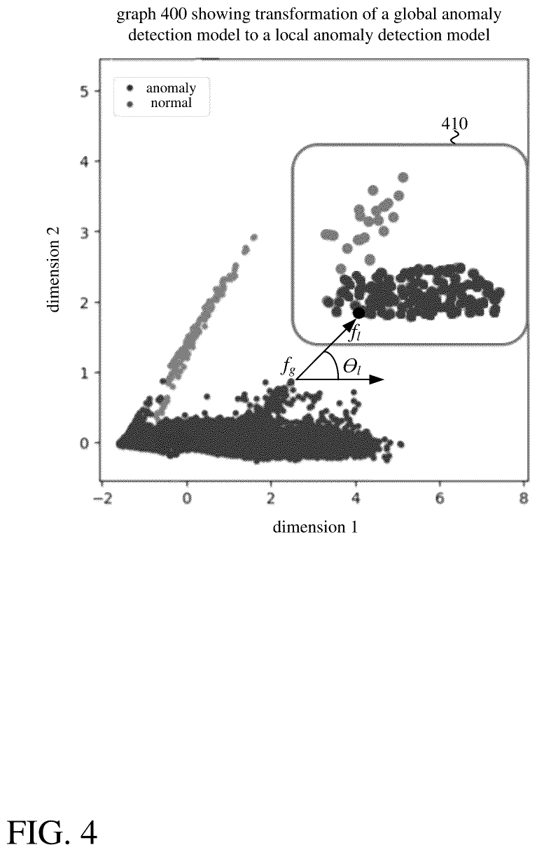

FIG. 4 shows an example graph (400) of data points upon transformation of a global anomaly detection model to a local anomaly detection model. Normal data points are denoted by a darker shade of gray, whereas anomalous data points are denoted by a lighter shade of gray. In the example, the x-axis is labeled dimension 1, whereas the y-axis is labeled dimension 2. In practice, dimension 1 and dimension 2 may each represent multiple features.

Graph (400) depicts data points for the same example global anomaly detection model shown in graph (300) of FIG. 3. In addition, graph (400) depicts data points for a local anomaly detection model (410) that was generated by multiplying the scaling factor θₗ and the sum of the global vector space B_{global} and the expected deviation δ_{g}. The angle shown in the graph (400) is representative of the scaling factor θₗ of the transformation function, which can be used to convert the global vector space to the local vector space.

### VII. EXAMPLE APPROACHES FOR LOCALIZING A GLOBAL ANOMALY DETECTION MODEL

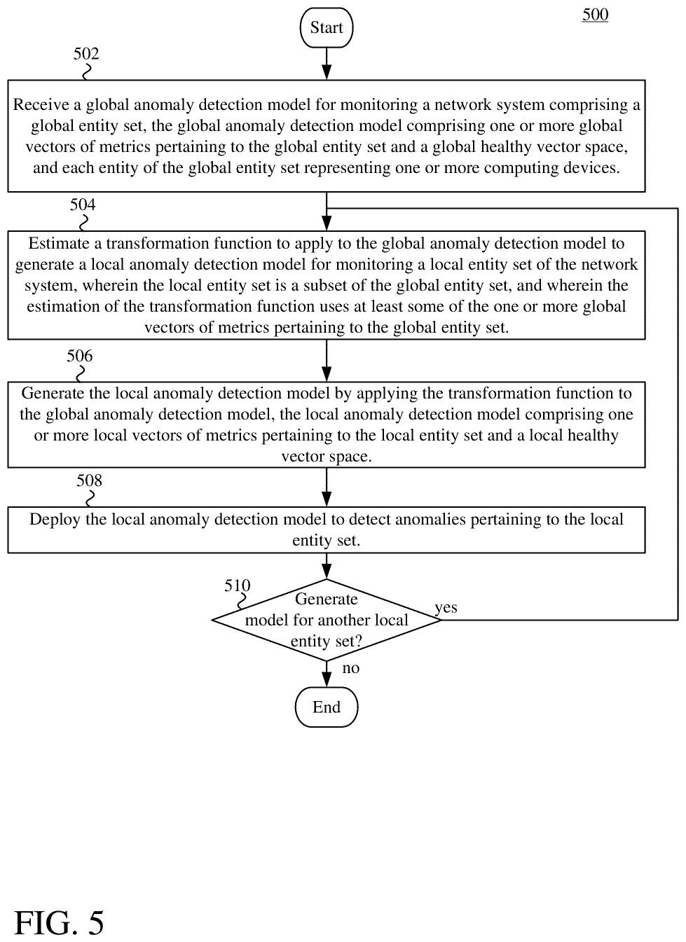

FIG. 5 shows a generalized technique (500) for localizing a global anomaly detection model. The technique (500) can be performed by an anomaly detection tool as described in the preceding sections, or by another tool or component.

With reference to FIG. 5, a transformation tool of the anomaly detection tool receives (502) a global anomaly detection model for monitoring a network system comprising a global entity set, the global anomaly detection model comprising one or more global vectors of metrics pertaining to the global entity set and a global healthy vector space, and each entity of the global entity set representing one or more computing devices. The global entity set, global anomaly detection model, one or more global vectors of metrics, and global healthy vector space can alternatively be referred to simply as an entity set, anomaly detection model, one or more vectors of metrics, and healthy vector space. As one example, the transformation tool can receive the global anomaly detection model from a model generator of the anomaly detection tool, e.g., after the model generator has generated the global anomaly detection model based on global time-series data. As another example, the transformation tool can fetch a global anomaly detection model which was previously generated by the model generator from memory (e.g., from a data repository of the network system backend). Alternatively, the global anomaly detection model may be generated by and received from another entity.

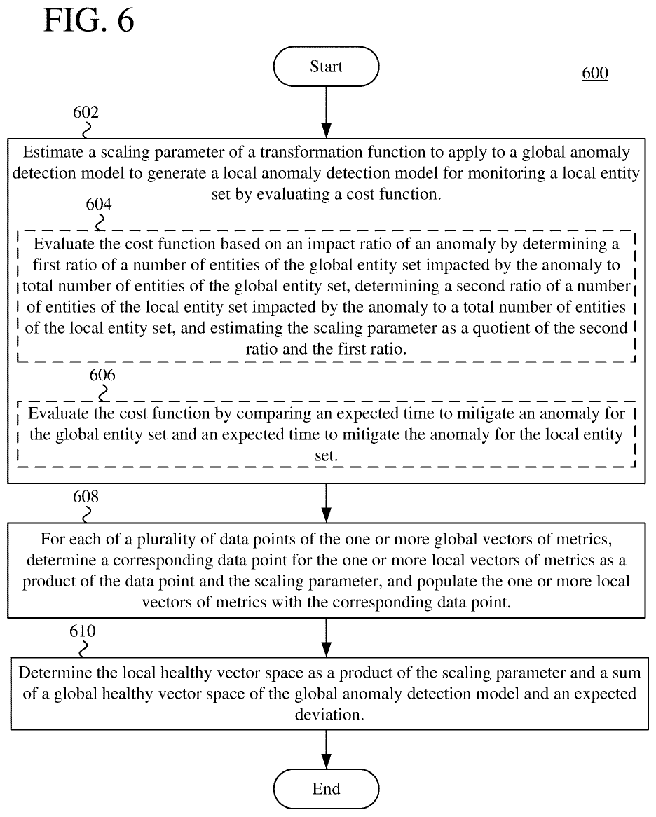

The transformation tool also estimates (504) a transformation function to apply to the global anomaly detection model to generate a local anomaly detection model for monitoring a local entity set of the network system, wherein the local entity set is a subset of the global entity set, and wherein the estimation of the transformation function uses at least some of the one or more global vectors of metrics pertaining to the global entity set. The estimation of the transformation function can be performed as described with reference to FIG. 6, or performed in some other way described herein.

The transformation tool then generates (506) the local anomaly detection model by applying the transformation function to the global anomaly detection model. The local anomaly detection model comprises one or more local vectors of metrics pertaining to the local entity set and a local healthy vector space. Subsequently, a deployment tool of the anomaly detection tool deploys (508) the local anomaly detection model to detect anomalies pertaining to the local entity set.

As shown, after the local anomaly detection model has been deployed, the technique (500) proceeds to determine (510) whether a local anomaly detection model should be generated for another local entity set. If so, technique (500) returns to step (504) to repeat the process for the other local entity set. Otherwise, if is it determined that no other local anomaly detection models should be generated, technique (500) ends.

While technique (500) depicts sequential generation of multiple local anomaly detection models, the generation of multiple local anomaly detection models may alternatively be performed concurrently (e.g., in parallel). For example, in practice, the anomaly detection tool may perform each of steps (504)-(508) for a plurality of local entity sets, in parallel, in order to generate respective local anomaly detection models for the local entity sets. As an illustrative example, a computer system can be configured to perform operations for localization of a global anomaly detection model for a network system comprising a global entity set, a first local entity set which is a subset of the global entity set, and a second local entity set which is a different subset of the global entity set. The operations can include receiving a global anomaly detection model for monitoring a network system comprising the global entity set, estimating a first transformation function to apply to the global anomaly detection model to generate a first local anomaly detection model for monitoring the first local entity set, estimating a second transformation function to apply to the global anomaly detection model to generate a second local anomaly detection model for monitoring the second local entity set, generating the first local anomaly detection model by applying the first transformation function to the global anomaly detection model, generating the second local anomaly detection model by applying the second transformation function to the global anomaly detection model, deploying the first local anomaly detection model in the network system to perform anomaly detection for the first local entity set, deploying the second local anomaly detection model in the network system to perform anomaly detection for the second local entity set, and outputting results of the anomaly detection for the first local entity set and the second local entity set.

FIG. 6 shows a generalized technique (600) for estimating a transformation function to apply to a global anomaly detection model to generate a local anomaly detection model for monitoring a local entity set. The technique (600) can be performed by an anomaly detection tool as described in the preceding sections, or by another tool or component. The technique (600) can be performed in conjunction with technique (500) of FIG. 5 (e.g., at step (504)).

With reference to FIG. 6, the anomaly detection tool estimates (602) a scaling parameter of a transformation function to apply to a global anomaly detection model to generate a local anomaly detection model for monitoring a local entity set by evaluating a cost function. Optionally, evaluating the cost function can include evaluating (604) the cost function based on an impact ratio of an anomaly by determining a first ratio of a number of entities of the global entity set impacted by the anomaly to total number of entities of the global entity set, determining a second ratio of a number of entities of the local entity set impacted by the anomaly to a total number of entities of the local entity set, and estimating the scaling parameter as a quotient of the second ratio and the first ratio.

As another example, evaluating the cost function can optionally include evaluating (606) the cost function by comparing an expected time to mitigate an anomaly for the global entity set and an expected time to mitigate the anomaly for the local entity set.

Next, for each of a plurality of data points of the one or more global vectors of metrics, the anomaly detection tool determines (608) a corresponding data point for the one or more local vectors of metrics as a product of the data point and the scaling parameter, and populates the one or more local vectors of metrics with the corresponding data point.

The anomaly detection tool then determines (610) the local healthy vector space as a product of the scaling parameter and a sum of a global healthy vector space of the global anomaly detection model and an expected deviation.

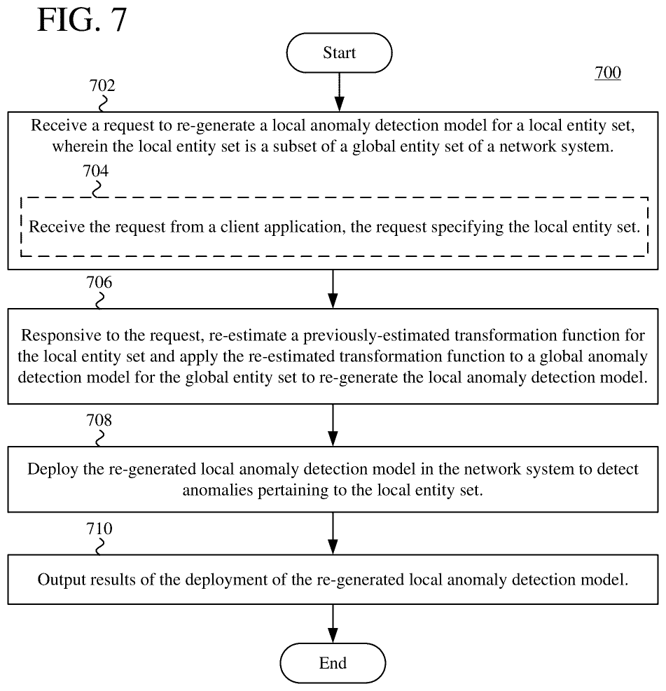

FIG. 7 shows a generalized technique (700) for re-estimating a transformation function to apply to a global anomaly detection model to re-generate a local anomaly detection model for monitoring a local entity set. The technique (700) can be performed by an anomaly detection tool as described in the preceding sections, or by another tool or component.

As shown, the anomaly detection tool receives (702) a request to re-generate a local anomaly detection model for a local entity set, wherein the local entity set is a subset of a global entity set of a network system. In some examples, the request to re-generate the local anomaly detection model for the local entity set is received (704) from a client application and specifies the local entity set. The client application may provide user access to a service implemented by the network system. For example, if the global entity set collectively implements a cloud service, the client application may provide user access to the cloud service.

Responsive to the request, the anomaly detection tool re-estimates (706) a previously-estimated transformation function for the local entity set and applies the re-estimated transformation function to a global anomaly detection model for the global entity set to re-generate the local anomaly detection model.

The anomaly detection tool then deploys (708) the re-generated local anomaly detection model in the network system to detect anomalies pertaining to the local entity set, and outputs (710) results of the deployment of the local anomaly detection model.

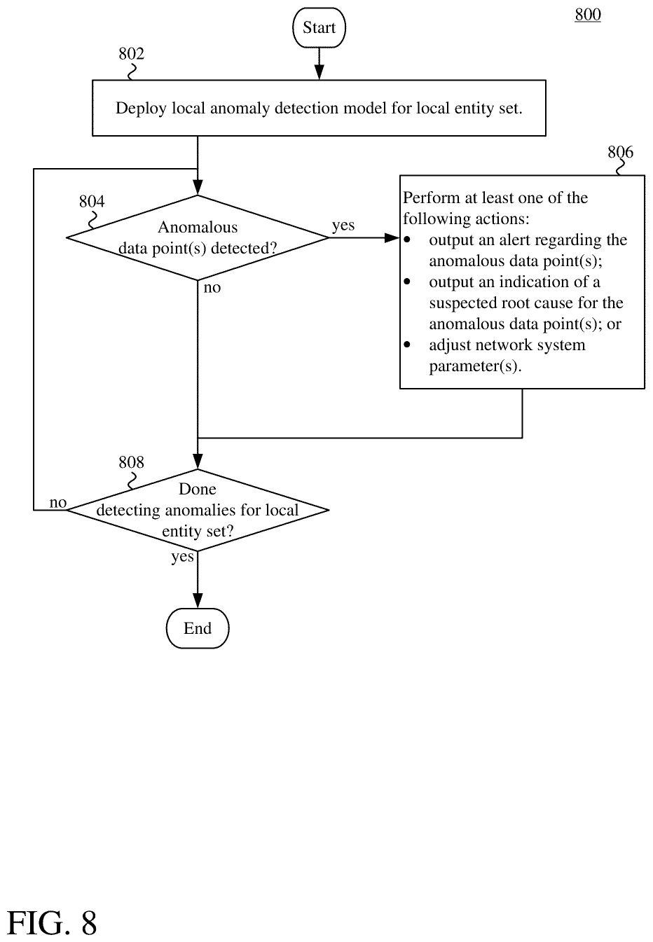

FIG. 8 shows a generalized technique (800) for outputting results of anomaly detection performed by a deployed local anomaly detection model. The technique (800) can be performed by an anomaly detection tool in conjunction with a network system backend, or by other tools or components. Technique (800) may be performed at step (508) of technique (500), for example.

As shown, a local anomaly detection model is deployed (802) for a local entity set. For example, a deployment tool of the anomaly detection tool can deploy the local anomaly detection model to process live time-series data associated with the local entity set. Next, technique (800) proceeds to determine (804) whether any anomalous data points have been detected. For example, a results analyzer of the anomaly detection tool can receive results from the deployment tool which indicate one or more anomalous data points identified via the local anomaly detection model.

If one or more anomalous data points have been detected by the local anomaly detection model, the results analyzer performs (806) at least one of the following actions: output an alert regarding the anomalous data point(s); output an indication of a suspected root cause for the anomalous data point(s); or adjust network system parameter(s). For example, the alert and/or indication of the suspected root cause can be output to a UI of the network system backend for display, and the adjusting of the network system parameter(s) can be implemented by the results analyzer transmitting a command to a parameter adjustment tool of the network system backend. As described herein, examples of network system parameters which may be adjusted based on anomaly detection results include a routing table of the network system, an allocation of computing resources within the network system, an allocation of memory within the network system, and the like.

Otherwise, if no anomalous data points were detected at (804), the anomaly detection tool proceeds to determine (808) whether to continue detecting anomalies for the local entity set. For example, the anomaly detection tool may continue detecting anomalies until instructed by the network system backend to stop deployment of the anomaly detection model for the local entity set. If the answer at (808) is NO, indicating that anomaly detection should be continued for the local entity set, the technique (800) returns to (804) to await detection of further anomalous data point(s). Otherwise, if the answer at (808) is YES, indicating that anomaly detection is completed for the local entity set, technique (800) ends.

For ease of explanation, technique (800) depicts outputting the results of a single deployed local anomaly detection model. In practice, the results of multiple deployed local anomaly detection models may be output concurrently (e.g., in parallel).

### VIII. EXAMPLE DISPLAY OF LOCAL ANOMALY DETECTION MODEL OUTPUT

The output of a deployed anomaly detection model output can be visualized in various ways. In some examples, alerts and root cause information output by an anomaly detection tool can be displayed on a UI in a dashboard format. For example, administrative users of a network system backend may view an anomaly detection dashboard for the network system via a UI.

For example, a dashboard can display information regarding global and local anomalies, such as global-level alerts and local-level alerts. The dashboard can be configured such that a user can click on a given alert to prompt display of additional information regarding the alert, such as root cause information for the alert. The alerts for different local spaces may be displayed separately (e.g., on separate tabs or windows).

Optionally, the dashboard can be configured to receive user input pertaining to the displayed anomaly information. For example, the dashboard may display a list of suggested actions to remedy a given anomaly, such that a user can select one of the actions for initiation.

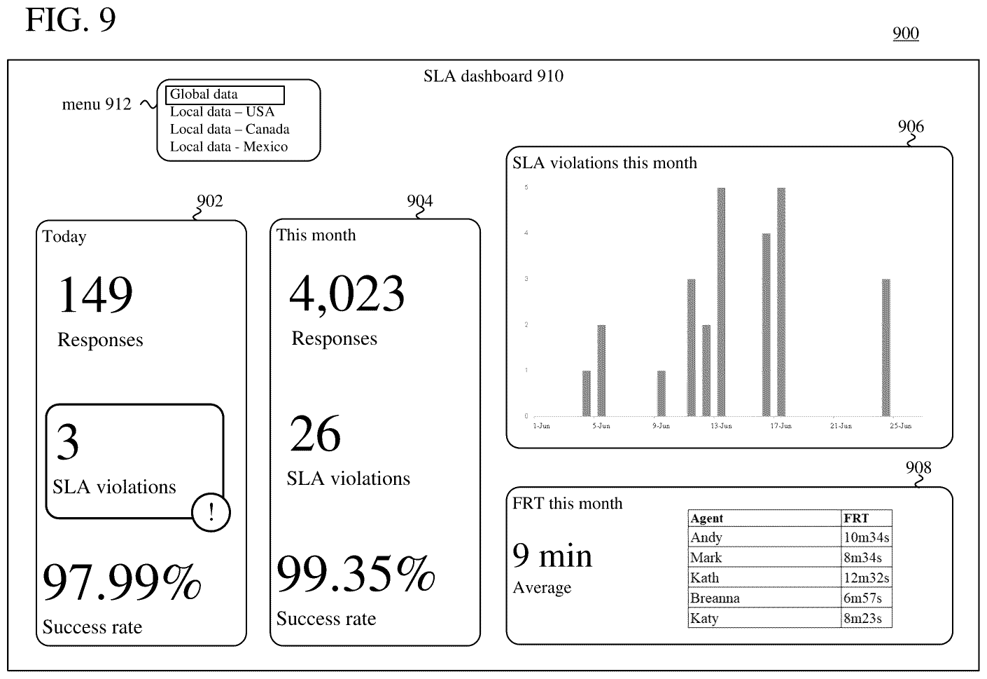

FIG. 9 shows features of a user interface (900) for an example SLA dashboard (910) for a cloud voice call service. The SLA dashboard (910) includes a daily information window (902), a monthly information window (904), a monthly graph window (906), a monthly first response time (FRT) window (908), and a menu (912). The menu (912) allows a user to select whether to display global data or local data; in the example, local data options include local data from the USA, local data from Canada, or local data from Mexico. Alternatively, local data options may be provided for other types of localities (e.g., geographic regions other than countries, call corridors, specific tenants, etc.). In the example, global data is selected from menu (912), and thus global data is displayed in SLA dashboard (910).

As shown, the daily information window (902) includes an indication of a number of responses (e.g., cloud voice call responses) that have occurred on the current day (149 responses in the depicted example), a number of SLA violations that have occurred on the current day (3 in the depicted example), and a success rate for cloud voice calls on the current day (97.99% in the depicted example). A box is displayed around the number of SLA violations with a circled exclamation point to alert the user (e.g., as each SLA violation may represent anomalous behavior of the network system implementing the cloud voice call service). The user interface (900) may be configured such that the user can click on the circled exclamation point to cause more information about the alert to be displayed.

Similarly, the monthly information window (904) includes an indication of a number of responses that have occurred during the current month (4,023 responses in the depicted example), a number of SLA violations that have occurred during the current month (26 in the depicted example), and a success rate for cloud voice calls during the current month (99.35% in the depicted example).

The monthly graph window (906) depicts a bar graph of the number of SLA violations during the current month. The x-axis represents the date, whereas the y-axis represents the number of SLA violations.

The FRT window (908) displays an average FRT for the current month (9 minutes in the depicted example), along with a chart listing call agents and their respective FRT averages. In this context, the FRT for a given call agent is the average time it takes for the call agent to provide an initial response to a customer's inquiry or request.

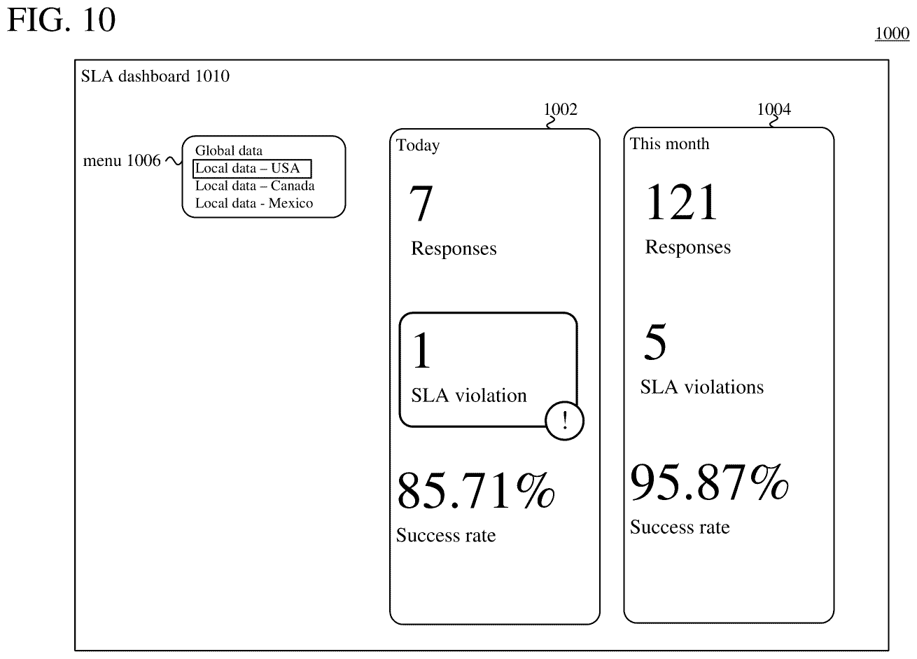

FIG. 10 shows features of a user interface (1000) for an example SLA dashboard (1010) for a cloud voice call service, which may be displayed responsive to user selection of the “Local data-USA” option from menu (912) of FIG. 9. Similar to SLA dashboard (910) of FIG. 9, the SLA dashboard (1010) includes a daily information window (1002), a monthly information window (1004), and a menu (1006). Like menu (912) of FIG. 9, the menu (1006) allows a user to select whether to display global data or local data; in the example, local data from the USA is displayed in the SLA dashboard (1010).

The data shown in SLA dashboard (1010) can originate from a local anomaly detection model that was generated based on a global anomaly detection model via the techniques described herein. For example, the local anomaly detection model that provides the data shown in SLA dashboard (1010) can be projected from the global anomaly detection model that provides the data shown in SLA dashboard (910) of FIG. 9, as described herein.

The daily information window (1002) includes an indication of a number of responses (e.g., cloud voice call responses) that have occurred on the current day in the selected locality (7 responses in the depicted example), a number of SLA violations that have occurred on the current day in the selected locality (1 in the depicted example), and a success rate for cloud voice calls on the current day in the selected locality (85.71% in the depicted example). As in FIG. 9, a box is displayed around the number of SLA violations with a circled exclamation point to alert the user, and the user interface (1000) may be configured such that the user can click on the circled exclamation point to cause more information about the alert to be displayed.

Similarly, the monthly information window (1004) includes an indication of a number of responses that have occurred during the current month in the selected locality (121 responses in the depicted example), a number of SLA violations that have occurred during the current month in the selected locality (5 in the depicted example), and a success rate for cloud voice calls during the current month in the selected locality (95.87% in the depicted example).

### IX. EXAMPLES

The innovative features described herein include the following examples.

| | Example |
|---|---|
| A1 | A computer-readable medium having stored thereon computer-executable |
| | instructions for causing a computer system, when programmed thereby, to perform |
| | operations comprising: |
| | receiving an anomaly detection model for monitoring a network system |
| | comprising an entity set, wherein the anomaly detection model comprises one or |
| | more vectors of metrics pertaining to the entity set and a healthy vector space, and |
| | wherein each entity of the entity set represents one or more computing devices; |
| | estimating a transformation function to apply to the anomaly detection model |
| | to generate a local anomaly detection model for monitoring a local entity set of the |
| | network system, wherein the local entity set is a subset of the entity set, and wherein |
| | the estimation of the transformation function uses at least some of the one or more |
| | vectors of metrics pertaining to the entity set; |
| | generating the local anomaly detection model by applying the transformation |
| | function to the anomaly detection model, the local anomaly detection model |
| | comprising one or more local vectors of metrics pertaining to the local entity set and |
| | a local healthy vector space; |
| | deploying the local anomaly detection model to perform anomaly detection |
| | for the local entity set; and |
| | outputting results of the anomaly detection for the local entity set. |
| A2 | The computer-readable medium of A1, wherein estimating the transformation |
| | function comprises estimating a scaling parameter of the transformation function by |
| | performing at least one of the following: |
| | regression analysis using the at least some of the one or more vectors of |
| | metrics pertaining to the entity set; |
| | machine learning using the at least some of the one or more vectors of |
| | metrics pertaining to the entity set; or |
| | evaluating a cost function using the at least some of the one or more vectors |
| | of metrics pertaining to the entity set. |
| A3 | The computer-readable medium of A2, wherein the one or more vectors of metrics |
| | pertaining to the entity set comprises a data point representing a number of entities |
| | of the entity set impacted by an anomaly within the network system, a data point |
| | representing a total number of entities of the entity set, a data point representing a |
| | number of entities of the local entity set impacted by the anomaly, and a data point |
| | representing a total number of entities of the local entity set, and wherein evaluating |
| | the cost function using the at least some of the one or more vectors of metrics |
| | pertaining to the entity set comprises: |
| | determining a first ratio of the number of entities of the entity set impacted |
| | by the anomaly within the network system to the total number of entities of the |
| | entity set; |
| | determining a second ratio of the number of entities of the local entity set |
| | impacted by the anomaly to the total number of entities of the local entity set; and |
| | estimating the scaling parameter as a quotient of the second ratio and the first |
| | ratio. |
| A4 | The computer-readable medium of A2 or A3, wherein the operations further |
| | comprise determining, using at least some of the one or more vectors of metrics |
| | pertaining to the entity set, an expected time to mitigate an anomaly for the entity set |
| | and an expected time to mitigate the anomaly for the local entity set, and wherein |
| | evaluating the cost function comprises: |
| | comparing the expected time to mitigate the anomaly for the entity set and |
| | the expected time to mitigate the anomaly for the local entity set. |
| A5 | The computer-readable medium of any one of A2-A4, wherein generating the local |
| | anomaly detection model by applying the transformation function to the anomaly |
| | detection model comprises: |
| | for each of a plurality of data points of the one or more vectors of metrics, |
| | determining a corresponding data point for the one or more local vectors of metrics |
| | as a product of the data point of the one or more vectors of metrics and the scaling |
| | parameter; and |
| | populating the one or more local vectors of metrics with the corresponding |
| | data point. |
| A6 | The computer-readable medium of any one of A2-A5, wherein generating the local |
| | anomaly detection model by applying the transformation function to the anomaly |
| | detection model comprises: |
| | determining the local healthy vector space as a product of the scaling |
| | parameter and a sum of the healthy vector space and an expected deviation. |
| A7 | The computer-readable medium of any one of A1-A6, wherein: |
| | data points of the one or more local vectors of metrics which are located |
| | outside of the local healthy vector space are designated as anomalous data points, |
| | and |
| | outputting the results of the anomaly detection for the local entity set |
| | comprises: |
| | determining that the one or more local vectors of metrics comprises |
| | one or more anomalous data points; and |
| | responsive to the determination, performing at least one of the |
| | following: |
| | outputting an alert regarding the one or more anomalous data |
| | points; or |
| | outputting an indication of a suspected root cause for the one |
| | or more anomalous data points, wherein the suspected root cause for |
| | a given anomalous data point among the one or more anomalous data |
| | points comprises one or more suspected reasons why the given |
| | anomalous data point is located outside of the local healthy vector |
| | space. |
| A8 | The computer-readable medium of any one of A1-A7, wherein: |
| | data points of the one or more local vectors of metrics which are located |
| | outside of the local healthy vector space are designated as anomalous data points, |
| | and |
| | outputting the results of the anomaly detection for the local entity set |
| | comprises: |
| | determining that the one or more local vectors of metrics comprises |
| | one or more anomalous data points; and |
| | responsive to the determination, adjusting one or more parameters of |
| | the network system. |
| A9 | The computer-readable medium of A8, wherein the one or more parameters of the |
| | network system comprise at least one of the following: |
| | a routing table of the network system; |
| | an allocation of computing resources within the network system; or |
| | an allocation of memory within the network system. |
| A10 | The computer-readable medium of any one of A1-A9, wherein the metrics of the one |
| | or more vectors of metrics and the one or more local vectors of metrics comprise at |
| | least one of the following: |
| | performance metrics; |
| | volume metrics; or |
| | client-side metrics. |
| A11 | The computer-readable medium of any one of A1-A10, wherein: |
| | the local entity set comprises one or more entities, and |
| | the one or more entities of the local entity set are associated with at least one |
| | of the following: |
| | a common geographic region; |
| | a common industry segment; |
| | a common tenant of a service; or |
| | a common communication corridor. |
| A12 | The computer-readable medium of any one of A1-A11, wherein: |
| | the anomaly detection model and the local anomaly detection model are |
| | multivariate anomaly detection models, |
| | data points of the one or more vectors of metrics each represent values of |
| | more than two of the metrics in the one or more vectors of metrics, and |
| | data points of the one or more local vectors of metrics each represent values |
| | of more than two of the metrics in the one or more local vectors of metrics. |
| A13 | The computer-readable medium of any one of A1-A12, wherein: |
| | the entity set is associated with a cloud-based communication service; |
| | the local entity set is one of a plurality of local entity sets which are subsets |
| | of the entity set; and |
| | each local entity set of the plurality of local entity sets is associated with a |
| | respective geographic region or communication corridor of the cloud-based |
| | communication service. |
| A14 | The computer-readable medium of A13, wherein the cloud-based communication |
| | service comprises a voice call service, and wherein the metrics in the one or more |
| | vectors of metrics comprise at least one of the following: |
| | a number of call attempts; |
| | a number of calls established; |
| | a number of minutes of use; |
| | a jitter measurement; |
| | a Session Engagement Establishment Ratio (SEER); or |
| | a Response Code distribution (RCD). |
| B1 | A computer system comprising a processing system and memory, wherein the |
| | computer system is configured to perform operations for localization of an anomaly |
| | detection model for a network system comprising an entity set, a first local entity set |
| | which is a subset of the entity set, and a second local entity set which is a different |
| | subset of the global entity set, wherein each entity of the entity set represents one or |
| | more computing devices, the operations comprising: |
| | receiving an anomaly detection model for monitoring a network system |
| | comprising the entity set, the anomaly detection model comprising a one or more |
| | vectors of metrics pertaining to the entity set and a healthy vector space; |
| | estimating a first transformation function to apply to the anomaly detection |
| | model to generate a first local anomaly detection model for monitoring the first local |
| | entity set; |
| | estimating a second transformation function to apply to the anomaly |
| | detection model to generate a second local anomaly detection model for monitoring |
| | the second local entity set; |
| | generating the first local anomaly detection model by applying the first |
| | transformation function to the anomaly detection model, the first local anomaly |
| | detection model comprising a first one or more local vectors of metrics pertaining to |
| | the first local entity set and a first local healthy vector space; |
| | generating the second local anomaly detection model by applying the second |
| | transformation function to the anomaly detection model, the second local anomaly |
| | detection model comprising a second one or more local vectors of metrics pertaining |
| | to the second local entity set and a second local healthy vector space; |
| | deploying the first local anomaly detection model in the network system to |
| | perform anomaly detection for the first local entity set; |
| | deploying the second local anomaly detection model in the network system |
| | to perform anomaly detection for the second local entity set; and |
| | outputting results of the anomaly detection for the first local entity set and |
| | the second local entity set. |
| B2 | The computer system of B1, wherein: |
| | the computer system implements an anomaly detection tool comprising a |
| | model generator and a transformation tool; |
| | the anomaly detection model is a machine learning model generated by the |
| | model generator; and |
| | the first transformation function and the second transformation function are |
| | each estimated by the transformation tool using at least some of the one or more |
| | vectors of metrics pertaining to the entity set by performing at least one of the |
| | following: |
| | regression analysis using the at least some of the one or more vectors |
| | of metrics pertaining to the entity set; |
| | machine learning using the at least some of the one or more vectors |
| | of metrics pertaining to the entity set; or |
| | evaluating a cost function using the at least some of the one or more |
| | vectors of metrics pertaining to the entity set. |
| B3 | The computer system of B1 or B2, wherein: |
| | generating the first local anomaly detection model by applying the first |
| | transformation function to the anomaly detection model comprises: |
| | for each of a plurality of data points of the one or more vectors of |
| | metrics, determining a corresponding data point for the first one or more |
| | local vectors of metrics as a product of the data point of the one or more |
| | vectors of metrics and a first scaling parameter of the first transformation |
| | function; |
| | populating the first one or more local vectors of metrics with the |
| | corresponding data point for the first one or more local vectors of metrics; |
| | and |
| | determining the first local healthy vector space as a product of the |
| | first scaling parameter and a sum of the healthy vector space and an expected |
| | deviation; and |
| | generating the second local anomaly detection model by applying the second |
| | transformation function to the anomaly detection model comprises: |
| | for each of the plurality of data points of the one or more vectors of |
| | metrics, determining a corresponding data point for the second one or more |
| | local vectors of metrics as a product of the data point of the one or more |
| | vectors of metrics and a second scaling parameter of the second |
| | transformation function; |
| | populating the second one or more local vectors of metrics with the |
| | corresponding data point for the second one or more local vectors of metrics; |
| | and |
| | determining the second local healthy vector space as a product of the |
| | second scaling parameter and a sum of the healthy vector space and the |
| | expected deviation. |
| C1 | A computer-readable medium having stored thereon computer-executable |
| | instructions for causing a computer system, when programmed thereby, to perform |
| | operations comprising: |
| | receiving a request to re-generate a local anomaly detection model for a local |
| | entity set, wherein the local entity set is a subset of an entity set of a network system, |
| | wherein each entity of the entity set represents one or more computing devices, |
| | wherein the local anomaly detection model comprises one or more local vectors of |
| | metrics pertaining to the local entity set and a local healthy vector space, and |
| | wherein data points of the one or more local vectors of metrics which are located |
| | outside of the local healthy vector space are designated as anomalous data points; |
| | responsive to the request: |
| | re-estimating a previously-estimated transformation function for the |
| | local entity set; and |
| | applying the re-estimated transformation function to an anomaly |
| | detection model for the entity set to re-generate the local anomaly detection model; |
| | deploying the re-generated local anomaly detection model to detect |
| | anomalies pertaining to the local entity set in the network system; and |
| | outputting results of the deployment of the local anomaly detection model. |
| C2 | The computer-readable medium of C1, wherein the request to re-generate the local |
| | anomaly detection model for the local entity set is received from a client application |
| | and specifies the local entity set, and wherein the local entity set comprises one or |
| | more entities. |
| C3 | The computer-readable medium of C2, wherein the entity set of the network system |
| | collectively implement a cloud-based service, and wherein the client application |
| | provides user access to the cloud-based service. |

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

We claim:

1. A computer-readable medium having stored thereon computer-executable instructions for causing a computer system, when programmed thereby, to perform operations comprising:
receiving an anomaly detection model for monitoring a network system comprising an entity set, wherein the anomaly detection model comprises one or more vectors of metrics pertaining to the entity set and a healthy vector space, and wherein each entity of the entity set represents one or more computing devices;
estimating a transformation function to apply to the anomaly detection model to generate a local anomaly detection model for monitoring a local entity set of the network system, wherein the local entity set is a subset of the entity set, and wherein the estimation of the transformation function uses at least some of the one or more vectors of metrics pertaining to the entity set;
generating the local anomaly detection model by applying the transformation function to the anomaly detection model, the local anomaly detection model comprising one or more local vectors of metrics pertaining to the local entity set and a local healthy vector space;
deploying the local anomaly detection model to perform anomaly detection for the local entity set; and
outputting results of the anomaly detection for the local entity set.

2. The computer-readable medium of claim 1, wherein estimating the transformation function comprises estimating a scaling parameter of the transformation function by performing at least one of the following:
regression analysis using the at least some of the one or more vectors of metrics pertaining to the entity set;
machine learning using the at least some of the one or more vectors of metrics pertaining to the entity set; or
evaluating a cost function using the at least some of the one or more vectors of metrics pertaining to the entity set.

3. The computer-readable medium of claim 2, wherein the one or more vectors of metrics pertaining to the entity set comprises a data point representing a number of entities of the entity set impacted by an anomaly within the network system, a data point representing a total number of entities of the entity set, a data point representing a number of entities of the local entity set impacted by the anomaly, and a data point representing a total number of entities of the local entity set, and wherein evaluating the cost function using the at least some of the one or more vectors of metrics pertaining to the entity set comprises:
determining a first ratio of the number of entities of the entity set impacted by the anomaly within the network system to the total number of entities of the entity set;
determining a second ratio of the number of entities of the local entity set impacted by the anomaly to the total number of entities of the local entity set; and
estimating the scaling parameter as a quotient of the second ratio and the first ratio.

4. The computer-readable medium of claim 2, wherein the operations further comprise determining, using at least some of the one or more vectors of metrics pertaining to the entity set, an expected time to mitigate an anomaly for the entity set and an expected time to mitigate the anomaly for the local entity set, and wherein evaluating the cost function comprises:
comparing the expected time to mitigate the anomaly for the entity set and the expected time to mitigate the anomaly for the local entity set.

5. The computer-readable medium of claim 2, wherein generating the local anomaly detection model by applying the transformation function to the anomaly detection model comprises:
for each of a plurality of data points of the one or more vectors of metrics, determining a corresponding data point for the one or more local vectors of metrics as a product of the data point of the one or more vectors of metrics and the scaling parameter; and
populating the one or more local vectors of metrics with the corresponding data point.

6. The computer-readable medium of claim 2, wherein generating the local anomaly detection model by applying the transformation function to the anomaly detection model comprises:
determining the local healthy vector space as a product of the scaling parameter and a sum of the healthy vector space and an expected deviation.

7. The computer-readable medium of claim 1, wherein:
data points of the one or more local vectors of metrics which are located outside of the local healthy vector space are designated as anomalous data points, and
outputting the results of the anomaly detection for the local entity set comprises:
determining that the one or more local vectors of metrics comprises one or more anomalous data points; and
responsive to the determination, performing at least one of the following:
outputting an alert regarding the one or more anomalous data points; or
outputting an indication of a suspected root cause for the one or more anomalous data points, wherein the suspected root cause for a given anomalous data point among the one or more anomalous data points comprises one or more suspected reasons why the given anomalous data point is located outside of the local healthy vector space.

8. The computer-readable medium of claim 1, wherein:
data points of the one or more local vectors of metrics which are located outside of the local healthy vector space are designated as anomalous data points, and
outputting the results of the anomaly detection for the local entity set comprises:
determining that the one or more local vectors of metrics comprises one or more anomalous data points; and
responsive to the determination, adjusting one or more parameters of the network system.

9. The computer-readable medium of claim 8, wherein the one or more parameters of the network system comprise at least one of the following:
a routing table of the network system;
an allocation of computing resources within the network system; or
an allocation of memory within the network system.

10. The computer-readable medium of claim 1, wherein the metrics of the one or more vectors of metrics and the one or more local vectors of metrics comprise at least one of the following:
performance metrics;
volume metrics; or
client-side metrics.

11. The computer-readable medium of claim 1, wherein:
the local entity set comprises one or more entities, and
the one or more entities of the local entity set are associated with at least one of the following:
a common geographic region;
a common industry segment;
a common tenant of a service; or
a common communication corridor.

12. The computer-readable medium of claim 1, wherein:
the anomaly detection model and the local anomaly detection model are multivariate anomaly detection models,
data points of the one or more vectors of metrics each represent values of more than two of the metrics in the one or more vectors of metrics, and
data points of the one or more local vectors of metrics each represent values of more than two of the metrics in the one or more local vectors of metrics.

13. The computer-readable medium of claim 1, wherein:
the entity set is associated with a cloud-based communication service;
the local entity set is one of a plurality of local entity sets which are subsets of the entity set; and
each local entity set of the plurality of local entity sets is associated with a respective geographic region or communication corridor of the cloud-based communication service.

14. The computer-readable medium of claim 13, wherein the cloud-based communication service comprises a voice call service, and wherein the metrics in the one or more vectors of metrics comprise at least one of the following:
a number of call attempts;
a number of calls established;
a number of minutes of use;
a jitter measurement;
a Session Engagement Establishment Ratio (SEER); or
a Response Code distribution (RCD).

15. A computer system comprising a processing system and memory, wherein the computer system is configured to perform operations for localization of an anomaly detection model for a network system comprising an entity set, a first local entity set which is a subset of the entity set, and a second local entity set which is a different subset of the entity set, wherein each entity of the entity set represents one or more computing devices, the operations comprising:
receiving an anomaly detection model for monitoring a network system comprising the entity set, the anomaly detection model comprising one or more vectors of metrics pertaining to the entity set and a healthy vector space;
estimating a first transformation function to apply to the anomaly detection model to generate a first local anomaly detection model for monitoring the first local entity set;
estimating a second transformation function to apply to the anomaly detection model to generate a second local anomaly detection model for monitoring the second local entity set;
generating the first local anomaly detection model by applying the first transformation function to the anomaly detection model, the first local anomaly detection model comprising a first one or more local vectors of metrics pertaining to the first local entity set and a first local healthy vector space;
generating the second local anomaly detection model by applying the second transformation function to the anomaly detection model, the second local anomaly detection model comprising a second one or more local vectors of metrics pertaining to the second local entity set and a second local healthy vector space;
deploying the first local anomaly detection model in the network system to perform anomaly detection for the first local entity set;
deploying the second local anomaly detection model in the network system to perform anomaly detection for the second local entity set; and
outputting results of the anomaly detection for the first local entity set and the second local entity set.

16. The computer system of claim 15, wherein:
the computer system implements an anomaly detection tool comprising a model generator and a transformation tool;
the anomaly detection model is a machine learning model generated by the model generator; and
the first transformation function and the second transformation function are each estimated by the transformation tool using at least some of the one or more vectors of metrics pertaining to the entity set by performing at least one of the following:
regression analysis using the at least some of the one or more vectors of metrics pertaining to the entity set;
machine learning using the at least some of the one or more vectors of metrics pertaining to the entity set; or
evaluating a cost function using the at least some of the one or more vectors of metrics pertaining to the entity set.

17. The computer system of claim 15, wherein:
generating the first local anomaly detection model by applying the first transformation function to the anomaly detection model comprises:
for each of a plurality of data points of the one or more vectors of metrics, determining a corresponding data point for the first one or more local vectors of metrics as a product of the data point of the one or more vectors of metrics and a first scaling parameter of the first transformation function;
populating the first one or more local vectors of metrics with the corresponding data point for the first one or more local vectors of metrics; and
determining the first local healthy vector space as a product of the first scaling parameter and a sum of the healthy vector space and an expected deviation; and
generating the second local anomaly detection model by applying the second transformation function to the anomaly detection model comprises:
for each of the plurality of data points of the one or more vectors of metrics, determining a corresponding data point for the second one or more local vectors of metrics as a product of the data point of the one or more vectors of metrics and a second scaling parameter of the second transformation function;
populating the second one or more local vectors of metrics with the corresponding data point for the second one or more local vectors of metrics; and
determining the second local healthy vector space as a product of the second scaling parameter and a sum of the healthy vector space and the expected deviation.

18. A computer-readable medium having stored thereon computer-executable instructions for causing a computer system, when programmed thereby, to perform operations comprising:
receiving a request to re-generate a local anomaly detection model for a local entity set, wherein the local entity set is a subset of an entity set of a network system, wherein each entity of the entity set represents one or more computing devices, wherein the local anomaly detection model comprises one or more local vectors of metrics pertaining to the local entity set and a local healthy vector space, and wherein data points of the one or more local vectors of metrics which are located outside of the local healthy vector space are designated as anomalous data points;
responsive to the request:
re-estimating a previously-estimated transformation function for the local entity set; and
applying the re-estimated transformation function to an anomaly detection model for the entity set to re-generate the local anomaly detection model;
deploying the re-generated local anomaly detection model to detect anomalies pertaining to the local entity set in the network system; and
outputting results of the deployment of the local anomaly detection model.

19. The computer-readable medium of claim 18, wherein the request to re-generate the local anomaly detection model for the local entity set is received from a client application and specifies the local entity set, and wherein the local entity set comprises one or more entities.

20. The computer-readable medium of claim 19, wherein the entity set of the network system collectively implement a cloud-based service, and wherein the client application provides user access to the cloud-based service.
